(19) United States
(12) Patent Application Publication
(10) Pub. No.: US 2026/0310167 A1
(43) Pub. Date: Oct. 8, 2026

(54) Design Fabrication for Modular Structure with Anticlastic Surface

(71) Applicant: The Trustees of the University of Pennsylvania, Philadelphia, PA (US)

(72) Inventor: Masoud Akbarzadeh, Philadelphia, PA (US)

(21) Appl. No.: 19/639,865

(22) Filed: Apr. 6, 2026

Related U.S. Application Data
(60) Provisional application No. 63/783,838, filed on Apr. 4, 2025.

(51) Int. Cl. G05B 19/4099; B28B 1/00; B28B 17/00; B33Y 50/00

(52) U.S. Cl. CPC G05B 19/4099; B28B 1/001; B28B 17/0081; B33Y 50/00; G05B 2219/35134; G05B 2219/49023

(57) ABSTRACT

Aspects of the present disclosure include computer-implemented systems and methods for generating slab designs for additive manufacturing. In examples, a processor receives design input parameters including span dimensions in two different directions, slab depth, and support locations, and generates a structural frame model defining force flow paths in both directions. Based on the force flow paths, the processor determines placement locations for internal cable conduits configured to enable post-tensioning in multiple directions. A volumetric modeling technique is applied to integrate a periodic anticlastic surface geometry, including a triply periodic minimal surface, with the structural frame model. A three-dimensional mesh model of a two-way floor slab incorporating the anticlastic surface geometry and internal cable conduits is generated, and fabrication data is output to enable additive manufacturing of the slab.

### CROSS-REFERENCE TO RELATED APPLICATIONS

This application claims the benefit of U.S. Provisional Patent Application No. 63/783,838, filed Apr. 4, 2025, which is incorporated by reference in its entirety for any and all purposes.

### GOVERNMENT RIGHTS

This invention was made with government support under DE-AR0001631 awarded by the Department of Energy. The government has certain rights in the invention.

### TECHNICAL FIELD

The disclosed technology relates to the design, fabrication, and construction of load-bearing structures.

### BACKGROUND

The historical design of ancient masonry structures continues to inspire the use of compression-dominant structures in the Architectural, Engineering, and Construction (AEC) sector because of their ability to perform well. However, such designs can provide efficiency challenges, particularly with respect to the amount of material, mass, and energy required to construct and recycle such structures.

### SUMMARY

The present technology relates to computer-implemented systems and methods for generating structural slab designs for additive manufacturing. In various aspects, a processor receives design input parameters defining boundary conditions including span dimensions in a first direction and a second direction different from the first direction, slab depth, and support locations. Based on the boundary conditions and one or more loading scenarios, the processor generates a structural frame model that defines force flow paths in both directions. Placement locations for a plurality of internal cable conduits are determined based on the force flow paths, with conduits extending in each direction to enable post-tensioning in multiple directions. A volumetric modeling technique is applied to integrate a periodic anticlastic surface geometry with the structural frame model, and a three-dimensional mesh model of a two-way floor slab is generated and output as fabrication data for additive manufacturing.

According to further aspects, the periodic anticlastic surface geometry comprises a triply periodic minimal surface having defined geometric characteristics such as wavelength and frequency parameters, including diamond-based geometries. The generated slab design can correspond to a two-way, post-tensioned floor structure and may be defined as a modular system comprising a plurality of individual segments configured to be unified by post-tensioning cables routed through internal cable conduits. In some examples, the fabrication data includes instructions for printing modular segments that form a funicular beam incorporating the periodic anticlastic surface. The three-dimensional mesh model may be evaluated against lifecycle metrics and design objectives, including minimizing mass, maximizing surface area, and maximizing structural strength, and may be iteratively updated based on such evaluations prior to fabrication.

The present technology further relates to advanced systems, methods, and devices for a prefabricated structure, such as a 3D printed concrete structure. Systems and methods further relate to a prefabricated, post-tensioned modular spanning structure with reduced mass and reinforcement as well as enhanced surface area for carbonation. The prefabricated structure can include a plurality of joined segments forming a tension and compression combined funicular beam. The spanning structural system may include a periodic anticlastic surface, and at least one tensioned cable running through an internal conduit provided along a length of the plurality of joined segments. The at least one tensioned cable generates a force through the plurality of joined segments to place the concrete structure in compression, unify the segments, and increase load-bearing capacity. According to various aspects, the tension and compression combined funicular beam forms a funicular beam. The tension and compression combined funicular beam can span at least 3 m, 5 m, 10 m, 15 m, 20 m, 25 m, 30 m.

In some examples, the periodic anticlastic surface is a triply periodic minimal surface. The periodic anticlastic surface comprises a diamond geometry. In other examples, additional geometries can be utilized. An interface between a first joined segment and a second joined segment can include a plane that is non-parallel to a plane perpendicular to a direction of compression force. The interface can be selected to maximize an area between joined segments. In some examples, the plurality of segments comprises at least one of a concrete material and a carbon-absorbing material.

A second cable—which can be tensioned—can be present, for example running through a second internal conduit provided along a length of the plurality of joined segments. The tensioned cables can be post-tensioned to one or more anchors on the ends of the prefabricated structure. The least one tensioned cable can be a steel cable. The at least one tensioned cable can enable the plurality of joined segments to distribute a shear load. For example, the at least one tensioned cable joins the segments, and embedded anticlastic surfaces assist in distributing shear loads.

A method for fabricating a prefabricated structure can include printing a plurality of segments. The plurality of segments can modularly form a tension and compression combined funicular beam comprising a periodic anticlastic surface, such as an embedded periodic anticlastic surface. An internal conduit can be provided through the plurality of segments, and the plurality of segments can be joined via at least one tensioned cable running through the internal conduit. The at least one tensioned cable can generate a compressive force to join the plurality of segments. This can enable supporting a load via the plurality of segments.

According to various aspects, a first joined segment and a second joined segment can be printed to maximize an interface area when joined together. Each segment can be joined using a second tensioned cable running through a second internal conduit provided through the plurality of segments. According to various aspects, a variety of cable layouts can be implemented. For example, top and bottom cables can be provided. As an example, bottom cables can be used to increase strength of the concrete beam, reduce tension forces through compression. Top cables can ensure continuity through the beam and may be post-tensioned differently than the bottom cables.

As discussed herein, the periodic anticlastic surface can be a triply periodic minimal surface. The periodic anticlastic surface can include a diamond geometry. The plurality of segments can include at least one of a concrete material and a carbon-absorbing material and the plurality of segments forms a funicular beam.

### BRIEF DESCRIPTION OF THE DRAWINGS

FIG. 1 illustrates a structure forming a funicular concrete beam with embedded anticlastic surfaces, diamond geometry.

FIG. 2 illustrates a digital-to-physical design and fabrication workflow.

FIG. 3 illustrates a fabricated prototype.

FIG. 4 illustrates a clay model fabricated using the in-house modular printer.

FIG. 5 illustrates an example rendering of canopy.

FIG. 6 illustrates a 3D concrete printed periodic anticlastic funicular canopy.

FIG. 7 illustrates an assembly concept of canopy exhibition.

FIGS. 8A-8B illustrate force and form diagrams of the geometry generated using (FIG. 8A) graphic statics, and (FIG. 8B) polyhedral graphic statics.

FIGS. 9A-9C illustrate periodic anticlastic surface and volume generation, with FIG. 9A illustrating a diamond unit cell and approximated polyhedral surface; FIG. 9B illustrating rhombi structures revealed by red and blue labyrinths; and FIG. 9C illustrating thickened diamond surfaces with blended cavities.

FIG. 10A illustrates finite element modelling.

FIG. 10B illustrates analysis, and comparison with other beam structures.

FIG. 11 illustrates continuous toolpath patches generated utilizing a dependency graph.

FIG. 12 illustrates a 1:2 scale (5 m) 3D concrete printed canopy.

FIG. 13 illustrates a machined foam, caster, rail system for assembly and post-tensioning.

FIG. 14 illustrates a 3D concrete print of a canopy.

Appendix A and Appendix B are submitted herewith. The contents of Appendix A and Appendix B are hereby incorporated by reference in their entirety. The material contained in these appendices provides detailed descriptions, diagrams, and examples that support and enhance the understanding of the technology discussed herein. Any references to specific sections, figures, or examples within Appendix A and Appendix B shall be considered as fully set forth within this application.

### DETAILED DESCRIPTION OF ILLUSTRATIVE EMBODIMENTS

Systems and methods relate to a prefabricated, post-tensioned modular spanning structure with reduced mass and reinforcement as well as enhanced surface area for carbonation. Aspects of the present disclosure include fabricating and constructing 3D-printed structures and post-tensioning construction technologies. Additional aspects include the design and efficient fabrication of a combined compression and tension funicular beam with periodic anticlastic, diamond surfaces, for building and bridge structural applications. In examples, a beam structure is formed from the combined compression and tension funicular system with minimized mass and optimized reinforcement. Periodic anticlastic surfaces can be embedded within the thrust network to inherently increase geometric stiffness. In consideration of construction, sustainability, and recyclability, structures can be designed as a modular system, consisting of multiple (e.g., two, three, four, five, six, seven, eight, nine, or more) individual segments, where each segment is 3D-printed using a multi-component concrete mix with a multi-axis industrial robot arm. Post-tensioning the nine individual segments together with cables, such as ungrouted steel cables can form a spanning structure, for example, a beam, floor, or bridge. The prefabricated modular, ungrouted assembly allows for the structure to be disassembled, and thereby readily separating concrete and steel construction materials to be recycled with minimal effort. The combined design, fabrication, and construction approaches ensure sustainable practices by achieving desired performance with reduced construction materials that can be effectively separated and recycled/reused.

Various aspects can beneficially reduce the overall quantity of material needed for construction. Other safety requirements can necessitate the inclusion of additional reinforcement, such as steel fibers, to enhance performance, but can limit the structure's ability to be recycled.

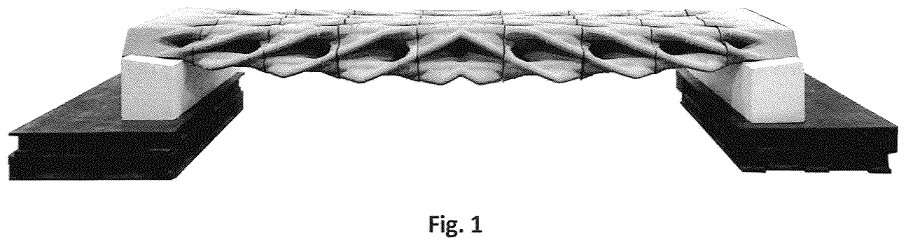

FIG. 1 illustrates a structure forming a funicular concrete beam with embedded anticlastic surfaces, diamond geometry, capable of spanning various lengths. In the illustrated example, a 5-meter beam is featured and made up of nine 3D concrete printed segments with steel cables threaded through the structure's channels. The steel cables can be post-tensioned to compress the segments together, and form the final concrete 3D-printed, funicular beam structure spanning and supporting its self-weight, notably resting on just two expanded polystyrene (EPS) foam blocks, thus demonstrating the lightweight nature of the beam. However, it should be appreciated that a variety of support conditions can be applied to the structure.

In examples, the structure can be a high-performing, sustainable modular spanning funicular beam developed using a comprehensive design method that utilizes new and existing fabrication and construction technologies. The result is a highly efficient structural system utilizing 3D concrete printing and post-tensioning, reducing the construction materials needed compared to conventional structural systems.

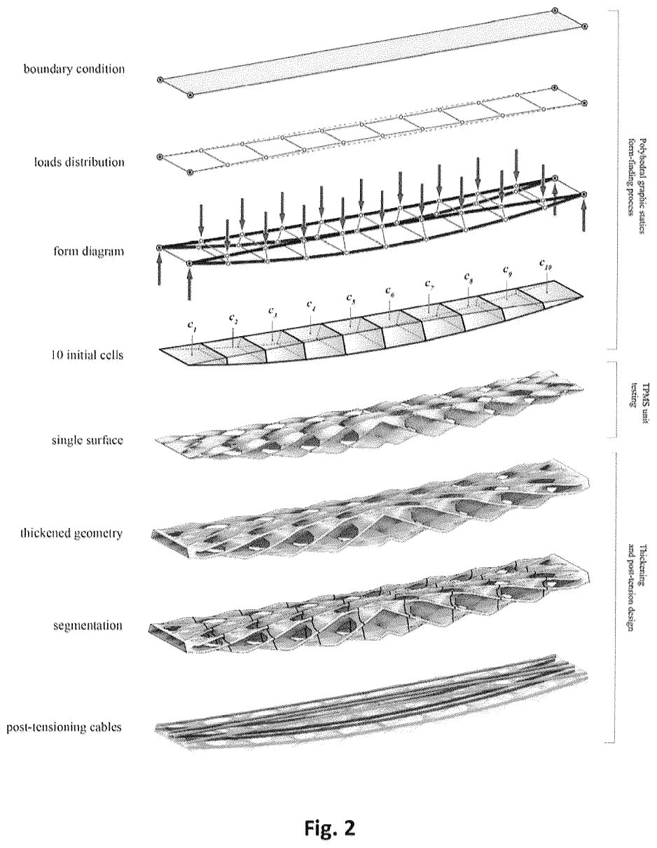

The comprehensive digital-to-physical design and fabrication workflow is illustrated for the structure illustrated in FIG. 2. A geometry-based structural design method of Polyhedral Graphic Statics can provide design freedom to achieve a structure that can bear specified loads as well as developed compression and tension forces. Polyhedral cells, defined from the resulting structural form, are used to contort, transform, and morph periodic anticlastic surfaces, specifically the diamond triply periodic minimal surface (TPMS) geometry to align with the principal stress directions. The diamond TPMS unit's geometry enhances the structural form's geometric stiffness and inherently provides the internal conduits for the post-tensioned cables resulting in a fully integrated material-structural system. 3D concrete printing allows for the effective realization of the innovative structural form, which otherwise could not be achieved using standard construction techniques. Prefabrication optimization and construction schemes were developed to address additive manufacturing constraints. To optimize the geometry for printability, Signed Distance Function (SDF) modeling can combine the funicular form and the TPMS geometry into a smooth, unified model. To print different spanning (e.g., 3 m, 5 m, 10 m, 15 m, 20 m, 25 m, 30 m, or more) structural prototypes, the design was divided into segments that ensured preferred structural behavior and optimization algorithms were developed to effectively slice the segmented geometry with non-parallel planes perpendicular to the direction of compression force flow. Additional computational algorithms were developed for efficient non-continuous printing to minimize the material dripping and to avoid collision since the geometry of the segments includes multiple disconnected loops. Without being bound to any particular theory, the prefabrication strategy can yield faster erection times, reduces soft construction costs, eliminates the need for formwork, allows for recyclability, and minimizes the overall carbon emissions of concrete construction.

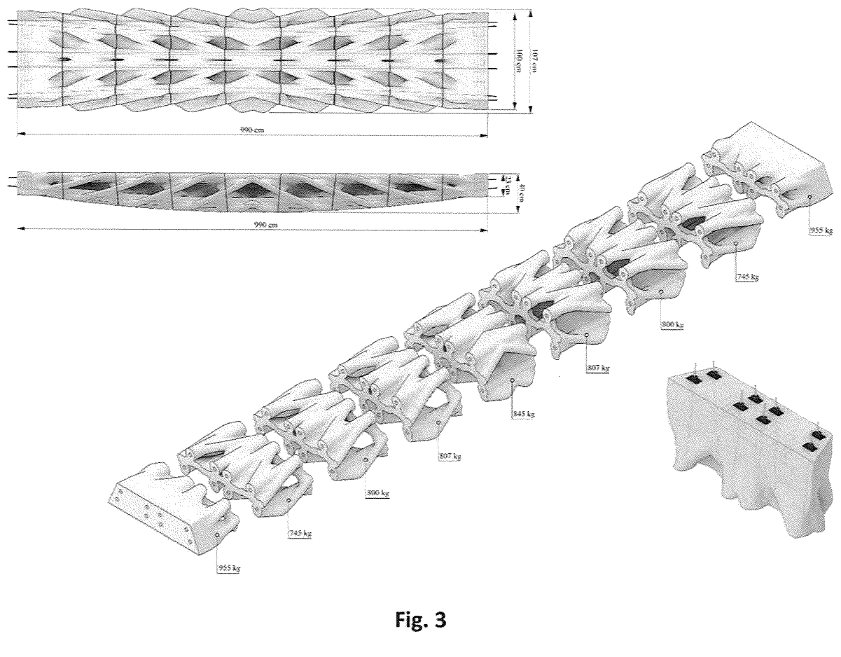

The overall structural load path and form, determined from Polyhedral Graphic Statics, directly considers compression and tensile forces through its funicular geometry. Periodic anticlastic diamond surfaces are embedded within the thrust network to increase overall geometric stiffness and distribute shear loads. The porosity and increased surface area related to the embedded diamond surfaces reduces the structure's embodied carbon by reducing the amount concrete material and enhancing carbonation potential. Specifically for the fabricated and tested 10-meter prototype (see, e.g., FIG. 3), carbon dioxide uptake can be significantly increased. In consideration of construction and recyclability, the structure is designed as a modular system, consisting of individual segments. Each segment can be 3D-printed using a multi-component concrete mix and with a multi-axis industrial robot arm, ideal for fabricating the geometrically complex embedded anticlastic surfaces without formwork, further reducing the amount of construction materials required, and waste produced. The segments are post-tensioned together with ungrouted steel cables. Altogether the post-tensioned 3D printed, funicular structure has minimal concrete and reinforcement and can be designed to span various lengths, at this time the maximum span reached has been 10 meters. Beneficially, the prefabricated modular, ungrouted assembly allows for the structure to be disassembled at the end of its life, readily separating concrete and steel construction materials to be recycled, as done after structural testing.

FIG. 2 illustrates a comprehensive digital-to-physical design workflow. The workflow includes multiple phases: (a) structural design and load path optimization using Polyhedral Graphic Statics, (b) geometric modeling and embedding of anticlastic periodic surfaces optimized with minimal overhangs for 3D-printing, (c) incorporation of post-tensioning cables along primary load paths, and (d) volumetric geometry generation and segmentation development considering concrete 3D printing constraints.

FIG. 3 illustrates a design of the 10-meter-long prefabricated, post-tensioned funicular beam. In consideration of construction and recyclability, this structure is designed as a modular system, consisting of nine individual segments that are post-tensioned together. Each segment was 3D-printed using a multicomponent concrete mix and with a multi-axis industrial robot arm. Each end segment was reinforced with additional material to resist bearing and bursting stress. Example details of the concrete printed modules, including their weights, and end-segment rebar cage, and post-tensioning anchors and cables are also specified.

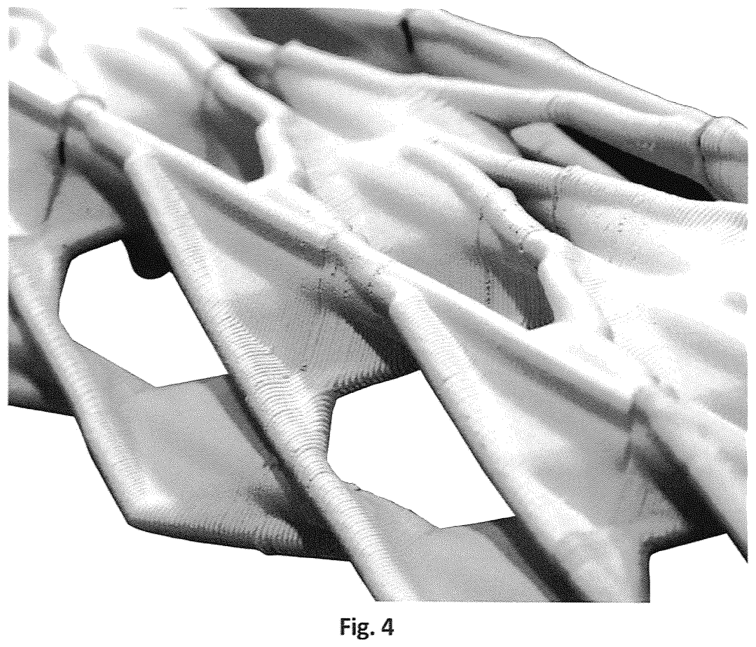

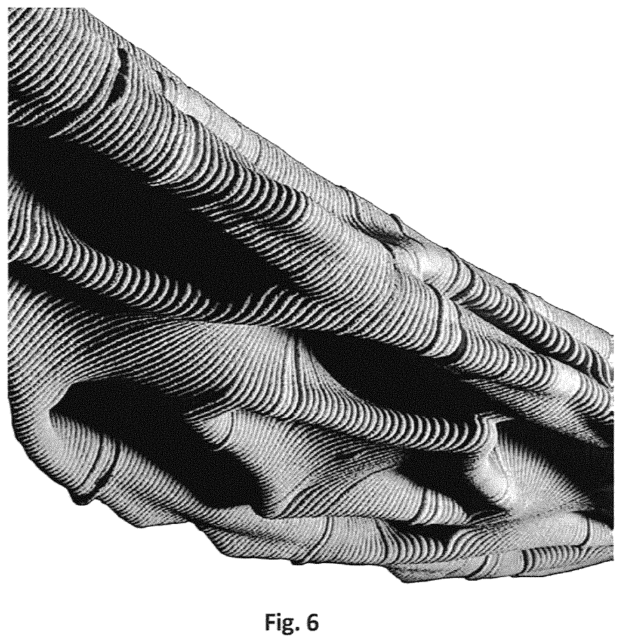

FIGS. 4-7 illustrate additional examples of the design and fabrication of a combined compression and tension funicular canopy with periodic anticlastic, diamond surfaces. FIG. 4 illustrates a clay model fabricated using an in-house modular printer, while FIG. 6 illustrates a 3D model of a concrete printed periodic anticlastic funicular canopy.

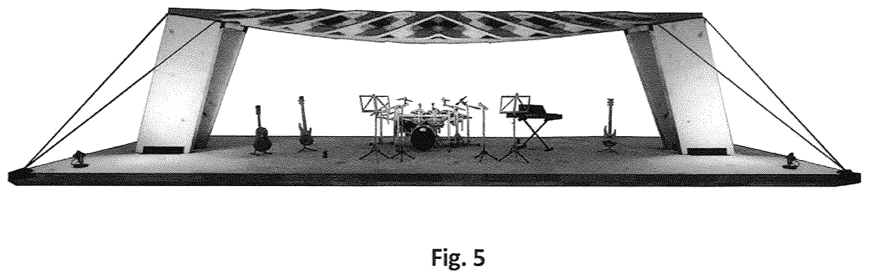

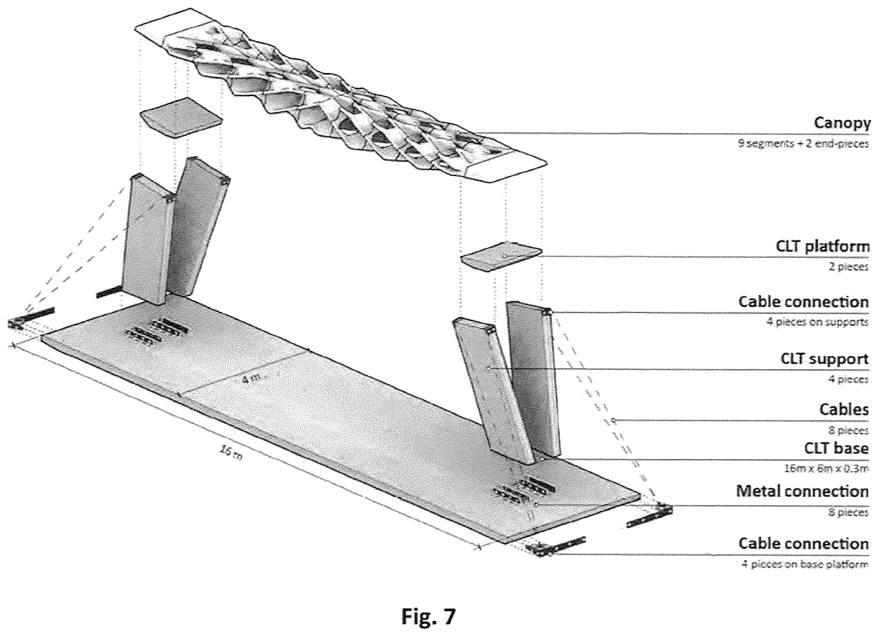

FIG. 5 illustrates an example canopy structure. Utilizing both 3D concrete printing (3DCP) and post-tensioning technologies, the canopy spans 10 m and is supported by a cross-laminated timber (CLT) platform (see also, FIG. 7). The structural form of this composite canopy directly considers both compressive and tensile forces, inherently developed in concrete structural systems, by distributing loads through its unique, minimal-mass geometry. The CLT platform suggests how the combination of a carbon-negative material and concrete can be used in contrast to common construction methods where concrete is typically used as the load-bearing support and wood as the spanning element. Hence, the lightweight design of the canopy spanning over and supported by the CLT platform, showcases the innovative use of these materials.

The exhibited designs go beyond compression only by embracing tension as an unavoidable force in systems resilient to different loading scenarios. Hence, a combined form-finding and fabrication approach was developed to achieve the innovative structure with the intention of also minimizing carbon through reduced materials and recyclability. Through the design freedom enabled by the design approach, 3DCP, and the use of post-tensioning, the final design favorably has minimal reinforcement while achieving the desired structural performance. Without being bound to any particular theory or embodiment, the aspects and examples discussed herein demonstrate how, through the combination of modem technologies and the development of a non-restrictive, comprehensive design approach, new structural forms can be achieved that lead to enhanced sustainable practices.

In examples, the geometry-based structural design method of polyhedral graphic statics (PGS) provided the design freedom to achieve a structure that is capable of dealing with developed compression and tension forces. Polyhedral cells, defined from the resulting structural form, were used to contort periodic anticlastic surfaces, specifically the diamond TPMS geometry to align with the principal stress directions. The diamond TPMS unit's geometry enhances the structural form's geometric stiffness and inherently provides the internal conduits for the post-tensioned cables, resulting in a fully integrated material-structural system.

The use of 3D concrete printing allowed for the effective realization of the innovative structural form, which otherwise could not be achieved using standard construction techniques. Prefabrication optimization and construction schemes were developed to address additive manufacturing constraints. To optimize for printability, signed distance function (SDF) combined the funicular form and the TPMS geometry into a smooth, unified model. To print the 10 m canopy, the design was divided into segments that ensured preferred structural behavior and optimization algorithms were developed to effectively slice the segmented geometry with non-parallel planes perpendicular to the direction of compression force flow. Additional computational algorithms were developed for efficient non-continuous printing to minimize the material dripping and to avoid collision, since the geometry of the segments includes multiple disconnected loops.

The overall design and fabrication approach in this work includes multiple intertwined innovative strategies that result in an extremely efficient structural system utilizing 3D concrete printing and post-tensioning that reduces the construction materials needed compared with conventional structural systems. The prefabrication strategy yields faster erection times, reduces soft construction costs, eliminates the need for formwork, allows for recyclability, and minimizes the overall carbon emissions of concrete construction.

### Design

A comprehensive computational methodology for form-finding, optimization, and digital fabrication was developed to design the canopy. The method begins with the generation of a geometric design using PGS, succeeded by the utilization of volumetric modelling (VM) for structural materialization. With respect to fabrication, details concerning 3DCP were considered through the development of print-specific optimization algorithms. The entire computational method for the canopy is illustrated as a workflow in FIG. 2. While applied here to the canopy, this computational method is general in that the process from design generation to digital fabrication preparation can be employed for a wide range of applications. The specifics of the method are discussed subsequently.

### Structural Form-Finding Through Polyhedral Graphic Statics

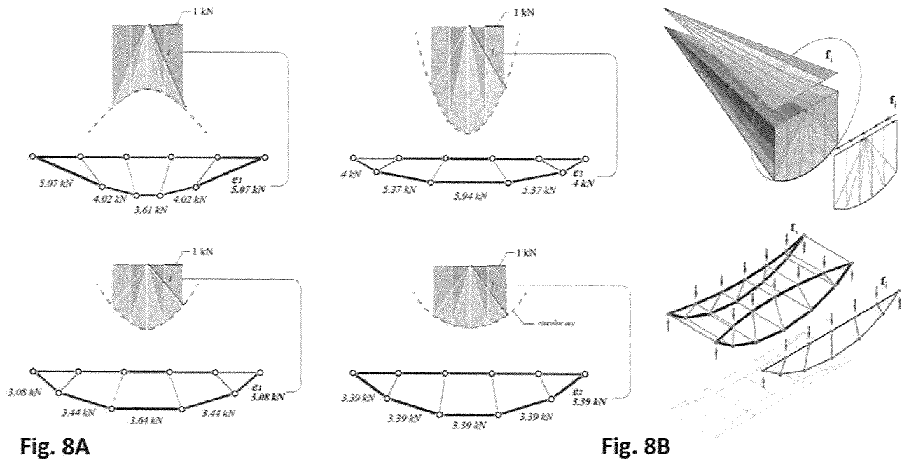

The structural form-finding process begins with the implementation of graphic statics. Conventional two-dimensional graphic statics establish a reciprocal relationship between form and force. This reciprocity principle allows for the considered forces and form to be altered without violating structural equilibrium, providing design freedom. With stability guaranteed, a range of stable structural forms can be generated considering both tension and compression forces (FIG. 8A). To effectively manage design requirements and material properties for the concrete canopy design, it is beneficial to maintain constant tension forces. In the context of 3D printing, concrete materials exhibit anisotropic behavior, meaning their properties vary depending on the direction of the applied load. The final constant tension force determined from graphic statics can be used as the post-tensioning force for the cables that run through the canopy to ideally produce constant compression. While the constant compression force intended to be developed from post-tensioning the system reduces the risk of localized stress concentrations and delamination of printed layers, the steel post-tensioning strands provide necessary steel reinforcement, allowing for the canopy to deal with tension forces that could be developed from other loading scenarios.

After using two-dimensional graphic statics to determine a geometry capable of dealing with combined tension and compression forces, PGS is utilized to extend the form and force in the third dimension (FIG. 8B). For this project, all the edges defining the two-dimensional force diagram are extruded to two points to establish a new three-dimensional force diagram. The same strategy used in two-dimensional graphic statics to ensure constant tension forces is also applied here. With the form established, segmented cells are defined to be used later for materialization and VM of the anticlastic surfaces.

### Embedding Periodic Anticlastic Surfaces

A surface is defined as anticlastic when the centers of curvatures are located on opposing sides, forming a hyperbolic paraboloid. The intricate structure of periodic anticlastic surfaces, their high surface-to-volume ratio, and their property of separating space into two interwoven but disconnected sub-spaces, make them promising candidates for a variety of applications, including, for example, medical implants, lightweight infill structures, and heat exchangers. While the gyroid surface is commonly the focus of various applications, TPMS, including the Diamond structure, is implemented here for the canopy's design because of its diamond cubic labyrinths. The diamond surface can be approximated by the implicit function:

$$cos x cos y cos z - sin x sin y sin z = 0$$

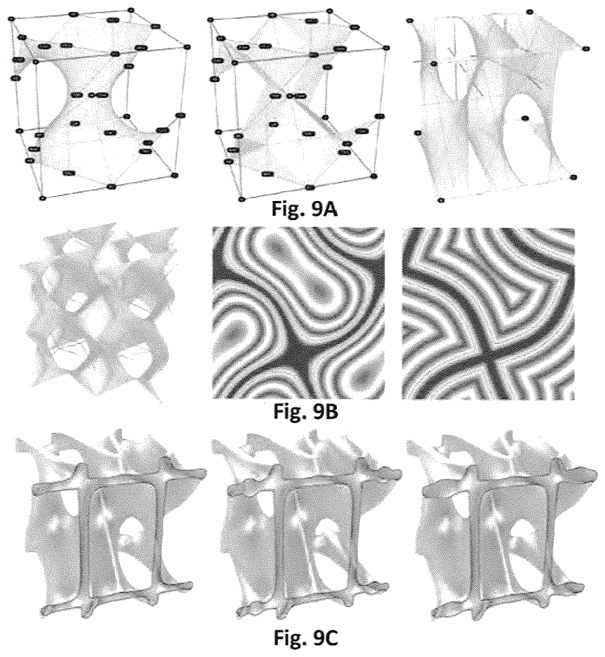

The surface is the 0-level isosurface of this function, separating space in a positive and a negative half-space. Unlike the gyroid, the diamond has several straight lines embedded in its surface that can be separated into three sets (FIG. 9A). A series of transformations are applied to rotate, translate, scale, and mirror the initial unit characteristics to align with the geometry generated through PGS. While different alignments can be explored, the continuity of the smooth surface must be guaranteed by enforcing the wavelength to be an integer multiple of 1 when cells are lined up and morphed into the form diagram, as done with the canopy illustrated in FIG. 2.

While the smooth zero mean curvature of minimal surfaces is beneficial in some applications, it poses some interesting challenges when 3D printed in concrete. The shallow horizontal parts of the surface at the saddle points constitute large overhangs that lead to printing in mid-air or can lead to structural collapse. To overcome this challenge, the implicit surface was replaced by a topologically identical polyhedral version (FIG. 9A), which natively contains angles acute enough to be readily printed. This polyhedral simplification (FIG. 9A) embraces the stunning relation between the labyrinths, Laves graphs, and VM with distance functions, whereby the diamond surface is equally distant from both labyrinths (i.e., continuous interwoven Voronoi cells), and appears to be made of planar rhombi (FIG. 9B).

### Volumetric Modelling

The 0-level isosurface of an implicit function—for example, an SDF—delimits the positive from the negative subspace: everything negative is considered inside the object, and everything positive outside. To materialize the surface itself, the object needs to be defined with an ‘inside’ and ‘outside.’ A straightforward way to achieve this is by creating a shell SDF in the form, where v is the original distance value and d is the desired thickness of the shell. This strategy works well for exact distance functions that exist for many primitives. However, since TPMS are approximated using trigonometric functions, their return values do not reflect actual correct metric distances (FIG. 9B). Applying the shell function does not result in a constant thickness offset of the original surface. The cells in the form diagram vary significantly in size and the same value for d would result in very different thicknesses of the shell along the canopy. Additionally, 3DCP requires the contour to be equally spaced—if the surfaces are too close then the extruded material overlaps and collides, diminishing the visual quality; if too far apart, the material does not bond, thereby diminishing the structural integrity. Therefore, a multi-step translation is applied between volumetric and mesh modelling. The polyhedral simplified unit cell single surface is deformed, preserving its topology such that it aligns the unit cube with the hexahedral cells of the form diagram (see, e.g., FIG. 2). The mesh for each quadrant of the canopy is converted into a distance field to allow for an exact offset (FIG. 9B).

The straight lines embedded in the surface align and are perpendicular with the main canopy's thrust lines—that is, the locations where tension and compression forces develop (FIG. 9A). This embedment allows a direct transfer of compression forces without buckling the doubly curved surface. Since the canopy will experience tensile forces in its lower regions, cavities for post-tensioning steel cables are integrated in the canopy's final design by locally dilating the opposite contours (print paths) of the initial shell. Capsules are created along each cable segment and united with the shell (FIG. 9C). With conventional boundary representation modelling, both thickening the mesh by a constant offset and the union of it with more objects would be prone to failure. Beneficially with VM, shapes are computed rather than constructed and the Boolean union computations are effortless. While a strict union leads to hard edges where the objects intersect, both slowing down the printing and being aesthetically displeasing, a smooth union is performed based on exponential functions, which instead seamlessly blends the cylinders into the shell (FIG. 9C).

### Numerical and Experimental Analysis

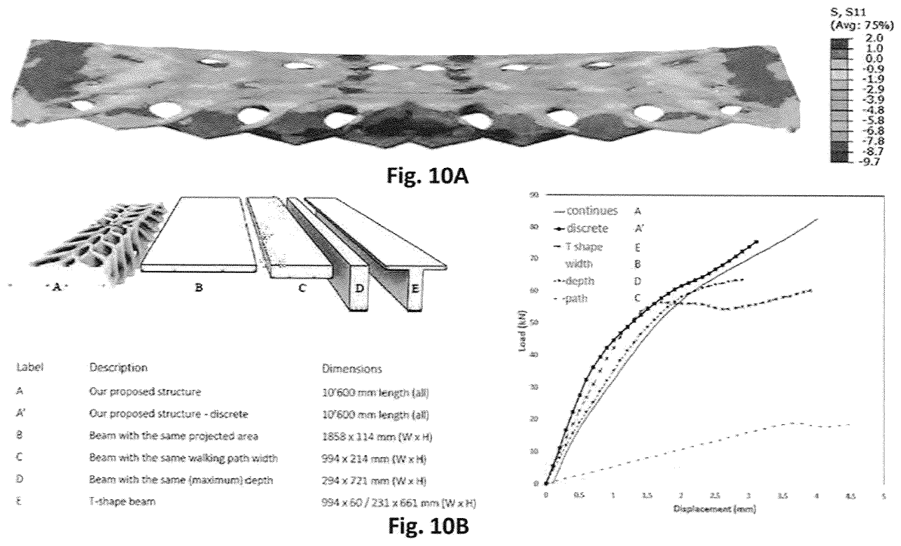

To understand the structural performance of the canopy, a finite element model was developed and analyzed (FIG. 10A). Considering different loads, such as self-weight and service loads, the finite element analyses indicate that the canopy's displacement is significantly less than the maximum displacement limit established by the American Association of State Highway and Transportation Officials design guidelines for spanning structures. A further study was conducted to understand the overall efficiency of the canopy compared with other common structural components that span similar distances. While the canopy initially shows a 14% strength reduction compared with the T-shape beam, by increasing the displacement, all the beams experience plastic deformation, while the canopy favorably shows elastic behavior. The performance of the canopy compared with other common structural components with the same boundary conditions, the position of reinforcement, the volume of concrete, and an applied displacement on the mid-span, are shown in FIG. 10B. To validate the numerical analyses, several physical models and experimental programs were developed to investigate the structural performance of the canopy. Scaled and full-scale canopies were printed, and their structural performance studied using physical load tests to characterize the properties of the 3D-printed concrete post-tensioned parts and match the analytical results of the finite element analysis with the observed behavior. These tests led to the development of post-tensioning strategies and techniques to further minimize needed reinforcement and ensure recyclability.

### Fabrication

To actualize the designed canopy, both 3D concrete printing and post-tensioning technologies were utilized. Unlike traditional concrete structures, no formwork is needed for the canopy and, indeed, could not be used because of the complexity of the canopy's form. Hence, a multi-component, accelerated 3D concrete printing system was used to print the canopy. The canopy was divided into nine segments, since, at 12 m, it would not be feasible to print the canopy all at once. The segments are combined by threading steel cables, ‘tying’ all segments together, and then compressed when post-tensioned. The assembled canopy is elevated and placed on CLT columns attached to a base for display. The display setup (see FIG. 7) was then devised.

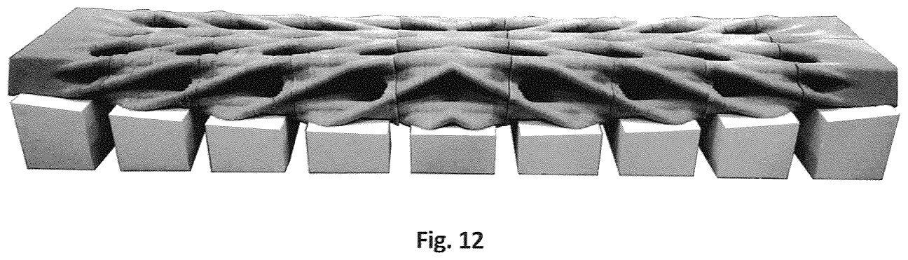

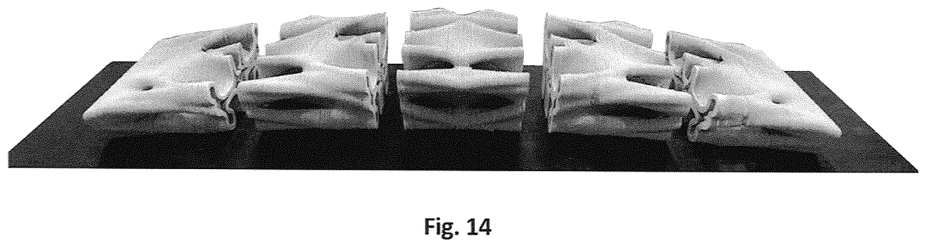

To ensure successful print and assembly, models of the canopy at four different scales, 1:10, 3:10, 1:2 (FIG. 12), and 1:1, were produced. The 1:10 scale model was printed to understand the nuances of the canopy's structural form using an in-house-developed desktop 3-axis clay printer, featuring a modularized compressive hopper and an auger-embedded extruder, and assembled by post-tensioning steel strands (FIG. 4). The assembly process of the 1:10 scale model was conducted using an upside assembly procedure. As a high-fidelity proof-of-concept, 3 m, half-scaled, and full-scaled versions of the canopy were printed using the multi-component, accelerated 3D concrete printing system, to best understand the printing process and the feasibility of assembly (see FIGS. 12-14). Overall, this prototyping informed needed printing procedures and assembly schemes on how to best digitally and physically fabricate and construct the full-scale canopy.

### Slicing and Toolpath Generation

Due to the complexity of the canopy's design and the limitations of the large-scale 3D concrete printer, the slicing and final toolpath were adapted to fit this specific process. Non-parallel slicing was used to get the layers perpendicular to the direction of compression forces, brought about by self-weight, during printing. To 3D print non-parallel layers, the printing parameters were adapted to keep the layer width constant. Because of the different inclinations of the layers, the resulting layer heights vary throughout the layer around an average value set to 10 mm. Varying layer heights combined with a constant printing speed and extrusion rate create variations in the layer width, around an average set to 30 mm. To avoid these layer width variations, an adaptation of the printing speed was implemented based on an algorithm that determines the specific layer height on each point of the toolpath. In case the layer height is lower than 10 mm, the printing speed is proportionally increased within the printing code (e.g., GCode, Rapid Code, etc.) to compensate for the layer height variation and keep the layer width of 30 mm, and vice versa.

One of the limitations when 3D printing is overhang—that is, parts of the print that slope outwards without support. When the overhang is too high, either the contact surface between the layers is too low to enable further layers to be deposited on top, or the material does not support the structure's self-weight before setting, and parts of the print collapse. Overhangs can be detected during the slicing process by extracting the normal vectors to the mesh model on each face, enabling easier refinement of the shape without creating waste through physical 3D-printing trials. Overall, a goal of reducing overhangs below 35° to maximize the success rate of the print was set.

When the overhang is too high, either the contact surface between the layers is too low to enable further layers to be deposited on top, or the material does not support the structure's self-weight before setting, and parts of the print collapse. Overhangs can be detected during the slicing process by extracting the normal vectors to the mesh model on each face, enabling easier refinement of the shape without creating waste through physical 3D-printing trials. Overall, a goal of reducing overhangs below 35° to maximize the success rate of the print was set.

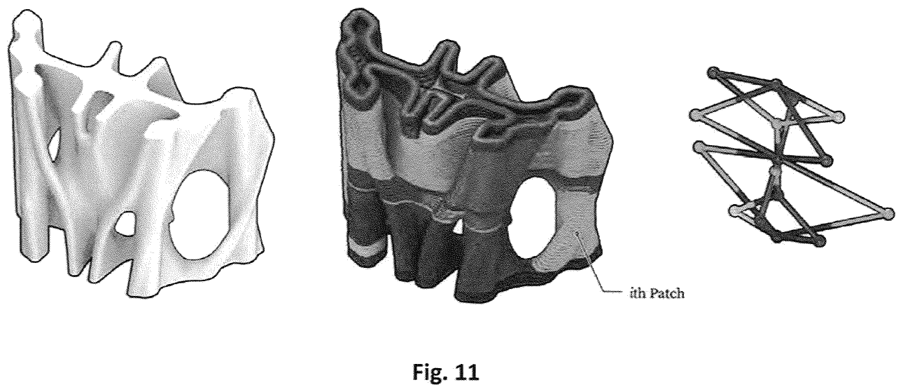

In addition, since the canopy has hollow sections, it could not be printed in one continuous path. Hence, a few layers were printed at once, and then a ‘jump’ was made to print the next group of layers. To avoid material dripping during jumps, the material extrusion was halted; however, prolonged stops can potentially lead to the printer nozzle clogging. To reduce the risk of clogs, which are more likely to occur if the extrusion is stopped for more than 2.5 seconds, the printing path was optimized to ensure jumps would occur outside of the printing area, preventing the dripping of excess material on the 3D-printed element and the collision between the nozzle and the printed body This optimization, shown in FIG. 11, reduced potential printing issues and improved the quality and aesthetics of the part.

### 3D Concrete Printing and Assembly

There are different technologies for 3D concrete printing available on the market, but the complexity of the canopy's design and the tool pathing needed indicated that a multi-component, accelerated system should be chosen for this project. The mix design incorporates three components and follows this process: mortar powder is mixed with plasticizer and water in a continuous mixer, and then it is pumped to a high shear rate mixing printhead mounted on a robotic arm. At the printhead the mix is accelerated and extruded through the nozzle. The accelerator allows for a fast concrete setting time and higher overhang values. In comparison to one-component systems, where the height of the print is bound with a slower setting time of the layers that must withstand the load of the subsequent layers, an accelerated system allows for taller prints in one session with overall thinner walls. Nevertheless, the use of an accelerator with the concrete mix can influence its interlayer bonding strength. However, this issue has been accounted for in the canopy's design and through trial printing.

Another important aspect of 3D concrete printing is testing the material properties and using correct values for the finite element calculations. For regular cementitious systems, material properties such as compressive strength and flexural strength are measured using cast elements according to precise standards and methods. Unlike in regular cementitious systems, a widely accepted standard for 3D-printing applications does not exist, and while the mechanical properties of the concrete-mortar itself can also be measured on cast elements, it is already known that the presence of layers will affect their actual mechanical properties. Therefore, during the evaluation of the project, several adaptations of existing standards were made to best measure the influence of printed layers on the material properties. Then, the cast concrete properties were compared with the printed properties in different directions of the print to best understand the mechanics and characteristics of the material.

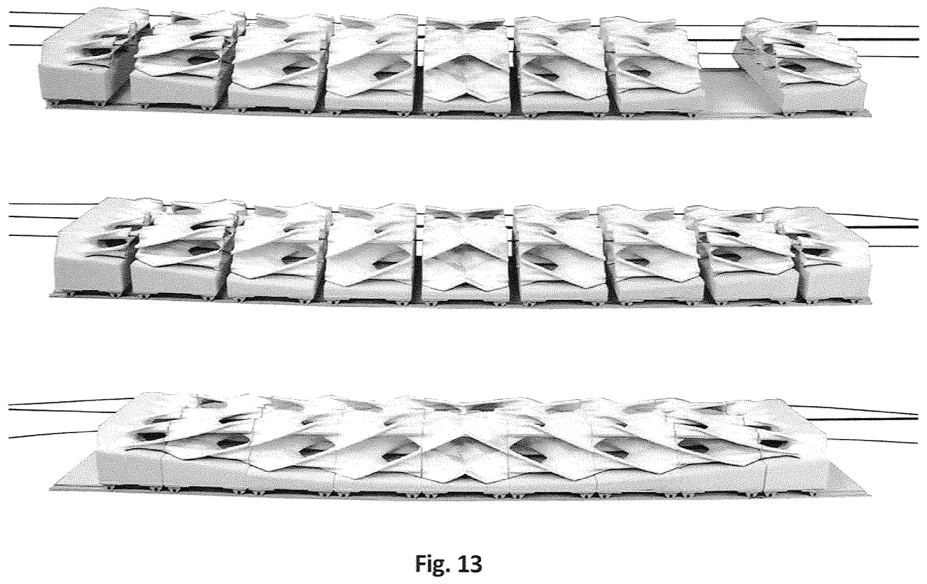

Through full-scale prototype printing, additional adjustments were made to the printing policy and tool pathing, as well as minor alternations to the design, to ensure successful fabrication. Between the prototyping and the larger-scale prints, an assembly strategy was developed. This strategy included how to best move, manipulate, and assemble the individual canopy segments for post-tensioning. An assembly sequence was developed using the small-scale prototype, whereby the canopy segments were placed on machined foam blocks with casters. Using a rail system, the individual pieces were placed together and post-tensioned (FIG. 13). Additional strategies for manipulating and placing the full-scale canopy for exhibition were implemented.

### CONCLUSION

The design, fabrication, and exhibition of the examples discussed herein demonstrate how the combination and development of new and existing methods and technologies can lead to high-performing composite structures with reduced material. The comprehensive computational methodology takes full advantage of the geometric capabilities of 3D concrete printing and directly addresses the unavoidable compression and tension forces developed in concrete structures by using post-tensioning. Overall, these technologies can be used for a more sustainable practice where high-performing structural systems can be produced and material recyclability can be achieved, reducing the overall carbon and embodied energy consumption.

### Aspects

The following Aspects are illustrative only and do not serve to limit the scope of the present disclosure or the appended claims. Any part or parts of any one or more Aspects can be combined with any part or parts of any one or more other Aspects.

Aspect 1. A pre-fabricated structure, comprising: a plurality of joined segments forming a funicular beam comprising a periodic anticlastic surface, and at least one tensioned cable running through an internal conduit provided along a length of the plurality of joined segments, wherein the at least one tensioned cable generates a compressive force through the plurality of joined segments to support a load. It should be understood that the present disclosure is not necessarily limited to prefabricated structures that include the disclosed features, as structures which include the disclosed features are also within the scope of the present disclosure.

Aspect 2. The prefabricated structure of Aspect 1, wherein the periodic anticlastic surface is a triply periodic minimal surface.

Aspect 3. The prefabricated structure of any one or more of Aspects 1-2, wherein the periodic anticlastic surface comprises a diamond geometry.

Aspect 4. The prefabricated structure of any one or more of Aspects 1-3, wherein an interface between a first joined segment and a second joined segment comprises a plane that is non-parallel to a plane perpendicular to a direction of compression force.

Aspect 5. The prefabricated structure of any one or more of Aspects 1-4, further comprising a second tensioned cable running through a second internal conduit provided along a length of the plurality of joined segments.

Aspect 6. The prefabricated structure of any one or more of Aspects 1-5, wherein the plurality of segments comprises at least one of a concrete material and a carbon-absorbing material.

Aspect 7. The prefabricated structure of any one or more of Aspects 1-6, wherein the at least one tensioned cable is a steel cable.

Aspect 8. The prefabricated structure of any one or more of Aspects 1-7, wherein the at least one tensioned cable enables the plurality of joined segments to distribute a shear load.

Aspect 9. The prefabricated structure of any one or more of Aspects 1-8, wherein the funicular beam forms an arch.

Aspect 10. The prefabricated structure of any one or more of Aspects 1-9, wherein the funicular beam spans at least 3 m, 5 m, 10 m, 15 m, 20 m, 25 m, 30 m.

Aspect 11. A method for fabricating a pre-fabricated structure, comprising: printing a plurality of segments, wherein the plurality of segments modularly form a funicular beam comprising a periodic anticlastic surface, wherein an internal conduit is provided through the plurality of segments; and joining the plurality of segments via at least one tensioned cable running through the internal conduit, wherein the at least one tensioned cable generates a compressive force to join the plurality of segments.

Aspect 12. The method of Aspect 11, further comprising supporting a load via the plurality of segments.

Aspect 13. The method of any one or more of Aspects 11-12, wherein a first joined segment and a second joined segment are printed to maximize an interface area when joined together.

Aspect 14. The method of any one or more of Aspects 11-13, further joining each segment using a second tensioned cable running through a second internal conduit provided through the plurality of segments.

Aspect 15. The method of any one or more of Aspects 11-14, further wherein the periodic anticlastic surface is a triply periodic minimal surface.

Aspect 16. The method of any one or more of Aspects 11-15, wherein the periodic anticlastic surface comprises a diamond geometry.

Aspect 17. The method of any one or more of Aspects 11-16, wherein the plurality of segments comprises at least one of a concrete material and a carbon-absorbing material.

Aspect 18. The method of any one or more of Aspects 11-17, wherein the plurality of segments forms a funicular beam.

Aspect 19. A computer-implemented method for generating a slab design for additive manufacturing, comprising receiving, by a processor, design input parameters including boundary conditions defining span dimensions in a first direction and in a second direction different from the first direction, a slab depth, and support locations; generating, by the processor, a structural frame model based on the boundary conditions and one or more loading scenarios, wherein the structural frame model defines force flow paths in both the first direction and the second direction; determining, by the processor, placement locations for a plurality of internal cable conduits based on the force flow paths, the plurality of internal cable conduits comprising a first set of conduits extending along the first direction and a second set of conduits extending along the second direction to enable post-tensioning in both directions; applying, by the processor, a volumetric modeling technique to integrate a periodic anticlastic surface geometry with the structural frame model, wherein the periodic anticlastic surface geometry comprises a triply periodic minimal surface having geometric characteristics including wavelength and frequency parameters; generating, by the processor, a three-dimensional mesh model of a two-way floor slab incorporating the periodic anticlastic surface geometry and the plurality of internal cable conduits; and outputting fabrication data comprising instructions for additive manufacturing of the two-way floor slab. It should be understood that the present disclosure is not necessarily limited to slab designs that include all of the disclosed features, as slab designs including one or more of the disclosed features are also within the scope of the present disclosure.

Aspect 20. The computer-implemented method of Aspect 19, wherein the slab design corresponds to a two-way, post-tensioned floor structure.

Aspect 21. The computer-implemented method of any one or more of Aspects 19-20, wherein the periodic anticlastic surface geometry comprises a diamond-shaped triply periodic minimal surface.

Aspect 22. The computer-implemented method of any one or more of Aspects 19-21, wherein the periodic anticlastic surface geometry comprises a diamond geometry.

Aspect 23. The computer-implemented method of any one or more of Aspects 19-22, wherein the two-way floor slab comprises a dome-shaped middle spanning section framed by post-tensioned beams.

Aspect 24. The computer-implemented method of any one or more of Aspects 19-23, wherein the three-dimensional mesh model defines the two-way floor slab as a modular system comprising a plurality of individual segments configured to be unified by post-tensioning cables extending through the plurality of internal cable conduits.

Aspect 25. The computer-implemented method of any one or more of Aspects 19-24, wherein the two-way floor slab comprises an anticlastic geometry.

Aspect 26. The computer-implemented method of any one or more of Aspects 19-25, wherein the fabrication data defines instructions for printing a plurality of segments that modularly form a funicular beam comprising the periodic anticlastic surface geometry, and wherein the plurality of internal cable conduits extend through the plurality of segments to enable joining the plurality of segments via at least one tensioned cable that generates a compressive force.

Aspect 27. The computer-implemented method of any one or more of Aspects 19-26, further comprising evaluating the three-dimensional mesh model using a lifecycle assessment.

Aspect 28. The computer-implemented method of Aspect 27, wherein the lifecycle assessment includes evaluating at least one of carbon emissions, cement usage, thermal modeling, and carbon absorption.

Aspect 29. The computer-implemented method of any one or more of Aspects 19-28, further comprising evaluating, by the processor, the three-dimensional mesh model against one or more design objectives.

Aspect 30. The computer-implemented method of Aspect 29, wherein the one or more design objectives comprise at least one of minimizing mass, maximizing surface area, and maximizing structural strength.

Aspect 31. A computer-implemented method for generating a slab design for additive manufacturing, comprising receiving, by a processor, design input parameters including boundary conditions defining span dimensions in a first direction and in a second direction different from the first direction, a slab depth, and support locations; generating, by the processor, a structural frame model based on the boundary conditions and one or more loading scenarios, wherein the structural frame model defines force flow paths in both the first direction and the second direction; determining, by the processor, placement locations for a plurality of internal cable conduits based on the force flow paths, the plurality of internal cable conduits comprising a first set of conduits extending along the first direction and a second set of conduits extending along the second direction to enable post-tensioning in both directions; applying, by the processor, a volumetric modeling technique to integrate a periodic anticlastic surface geometry with the structural frame model, wherein the periodic anticlastic surface geometry comprises a triply periodic minimal surface having geometric characteristics including wavelength and frequency parameters; generating, by the processor, a three-dimensional mesh model of a two-way floor slab incorporating the periodic anticlastic surface geometry and the plurality of internal cable conduits; updating the three-dimensional mesh model based on at least one of a lifecycle assessment and one or more design objectives; and outputting fabrication data comprising instructions for additive manufacturing of the two-way floor slab.

Aspect 32. The computer-implemented method of Aspect 31, wherein the lifecycle assessment includes at least one of carbon emissions, cement usage, thermal modeling, and carbon absorption.

Aspect 33. The computer-implemented method of Aspect 31 or Aspect 32, wherein the one or more design objectives comprise at least one of minimizing mass, maximizing surface area, and maximizing structural strength.

What is claimed:

1. A computer-implemented method for generating a slab design for additive manufacturing, the method comprising:
receiving, by a processor, design input parameters comprising boundary conditions including (i) span dimensions in a first direction and in a second direction different from the first direction, (ii) depth, and (iii) support locations;
generating, by the processor, a structural frame model based on the boundary conditions and loading scenarios, wherein the structural frame model defines force flow paths in both the first direction and the second direction;
determining, by the processor, placement locations for a plurality of internal cable conduits based on the force flow paths, wherein the plurality of internal cable conduits comprises a first set of conduits extending along the first direction and a second set of conduits extending along the second direction to enable post-tensioning in both directions;
applying, by the processor, a volumetric modeling technique to integrate a periodic anticlastic surface geometry with the structural frame model, wherein the periodic anticlastic surface geometry comprises a triply periodic minimal surface having geometric characteristics including wavelength and frequency parameters;
generating, by the processor, a three-dimensional mesh model of a two-way floor slab incorporating the periodic anticlastic surface geometry and the plurality of internal cable conduits; and
outputting fabrication data comprising instructions for additive manufacturing of the two-way floor slab.

2. The computer-implemented method of claim 1, wherein the slab design is of two-way, post-tensioned floor structure.

3. The computer-implemented method of claim 1, wherein the periodic anticlastic surface geometry comprises a diamond-shaped triply periodic minimal surface.

4. The computer-implemented method of claim 1, wherein the periodic anticlastic surface geometry comprises a diamond geometry.

5. The computer-implemented method of claim 1, wherein the two-way floor slab comprises a dome middle spanning section framed by post-tensioned beams.

6. The computer-implemented method of claim 1, wherein the three-dimensional mesh model defines the two-way floor slab as a modular system comprising a plurality of individual segments configured to be unified by post-tensioning cables through the plurality of internal cable conduits.

7. The computer-implemented method of claim 1, wherein the two-way floor slab comprises an anticlastic geometry.

8. The computer-implemented method of claim 1, wherein the fabrication data defines instructions for printing a plurality of segments that modularly form a funicular beam comprising the periodic anticlastic surface, wherein the plurality of internal cable conduits extend through the plurality of segments to enable joining the plurality of segments via at least one tensioned cable that generates a compressive force.

9. The computer-implemented method of claim 1, further comprising evaluating the three-dimensional mesh model with a lifecycle assessment.

10. The computer-implemented method of claim 9, wherein the lifecycle assessment includes at least one of carbon emissions, cement usage, thermal modeling, and carbon absorption.

11. The computer-implemented method of claim 1, further comprising: evaluating, by the processor, the three-dimensional mesh model against a plurality of design objectives.

12. The computer-implemented method of claim 11, wherein the design objectives comprise at least one of minimizing mass, maximizing surface area, and maximizing strength.

13. A computer-implemented method for generating a slab design for additive manufacturing, the method comprising:
receiving, by a processor, design input parameters comprising boundary conditions including (i) span dimensions in a first direction and in a second direction different from the first direction, (ii) depth, and (iii) support locations;
generating, by the processor, a structural frame model based on the boundary conditions and loading scenarios, wherein the structural frame model defines force flow paths in both the first direction and the second direction;
determining, by the processor, placement locations for a plurality of internal cable conduits based on the force flow paths, wherein the plurality of internal cable conduits comprises a first set of conduits extending along the first direction and a second set of conduits extending along the second direction to enable post-tensioning in both directions;
applying, by the processor, a volumetric modeling technique to integrate a periodic anticlastic surface geometry with the structural frame model, wherein the periodic anticlastic surface geometry comprises a triply periodic minimal surface having geometric characteristics including wavelength and frequency parameters;
generating, by the processor, a three-dimensional mesh model of a two-way floor slab incorporating the periodic anticlastic surface geometry and the plurality of internal cable conduits; and
updating the three-dimensional mesh model based on at least one of a lifecycle assessment and one or more design objectives; and
outputting fabrication data comprising instructions for additive manufacturing of the two-way floor slab.

14. The computer-implemented method of claim 13, wherein the lifecycle assessment includes at least one of carbon emissions, cement usage, thermal modeling, and carbon absorption.

15. The computer-implemented method of claim 13, wherein the one or more design objectives comprise at least one of minimizing mass, maximizing surface area, and maximizing strength.
